(19) United States
(12) Patent Application Publication
(10) Pub. No.: US 2022/0134457 A1
(43) Pub. Date: May 5, 2022

(54) GEAR PROCESSING APPARATUS AND METHOD

(71) Applicant: NATIONAL CENTRAL UNIVERSITY, Taoyuan (TW)

(72) Inventor: Yu-Ren WU, Taoyuan (TW)

(21) Appl. No.: 17/086,052

(22) Filed: Oct. 30, 2020

(51) Int. Cl. B23F 1/02

(52) U.S. Cl. CPC B23F 1/02

(57) ABSTRACT

The presented disclosure provides a gear processing apparatus, including a base, a bearing unit, a grinding unit, and a control unit. The bearing unit and the grinding unit are arranged on the base. The bearing unit is configured to carry the gear. The grinding unit includes a driving module and a grinding member connecting to the driving module. The grinding member can perform a motion of a plurality of axial directions relative to the bearing unit to contact the tooth surface of the gear. The control unit is electrically connected to the bearing unit and the grinding unit. The control unit is configured to control the driving module to apply additional motion to at least one of the plurality of axial directions during the grinding process to drive the grinding member to grind the tooth surface of the gear.

### FIELD OF THE INVENTION

The present disclosure relates to a gear processing apparatus, more particularly, to a gear processing apparatus that can change the grinding texture and roughness of the tooth surface of the gear.

### BACKGROUND OF THE INVENTION

Gear is a common transmission element, according to different use requirements, the gear can be made of different materials. For example, when the gear is applied to vehicle components or high-precision measurement equipment, in order to maintain stability and durability of operation, the gear is mostly made of hard metal or its alloys. For the tooth surface of the gear, grinding wheels are usually used for grinding to shape the tooth surface of the gear.

However, during the process of grinding wheel processing, much fine grinding texture that cannot be seen by the naked eye will be formed on the tooth surface of the gear. As the grinding wheel always rotates regularly in a single direction, the grinding texture is correspondingly roughly straight and parallel to each other. The grinding texture makes the gear easy to generate noise with a specific frequency during transmission and is not conducive to the formation of the lubricating film in the meshing area, which will affect the operation efficiency and quality of the gear. Therefore, how to reduce the possibility of noise generation by improving the effect of fine grinding texture on the tooth surface of the gear is indeed a subject worthy of research.

### SUMMARY OF THE INVENTION

The purpose of the present disclosure is to provide a gear processing apparatus that can change the grinding texture and roughness of the tooth surface of the gear.

To achieve the above object, the gear processing apparatus of the present disclosure includes a base, a bearing unit, a grinding unit, and a control unit. The bearing unit and the grinding unit are arranged on the base. The bearing unit is configured to bear the gear.

The grinding unit includes a driving module and a grinding member connected to the driving module, and the grinding member can perform a motion with a plurality of axial directions relative to the bearing unit to contact a tooth surface of the gear. The control unit is electrically coupled to the bearing unit and the grinding unit, and the control unit is configured to control the driving module to apply additional movement to at least one of the plurality of axial directions during a grinding process so as to drive the grinding element to grind the tooth surface of the gear.

In one embodiment of the present disclosure, the additional motion is a wave motion.

In one embodiment of the present disclosure, the wave motion is selected from at least one or a combination of the following groups: a sine wave motion, a square wave motion, a triangle wave motion, or a sawtooth wave motion.

In one embodiment of the present disclosure, the control unit can control the driving module to apply the different wave motions to the plurality of axial directions during the grinding process.

In one embodiment of the present disclosure, the control unit can control the driving module to apply the same wave motions with different amplitudes or frequencies to the plurality of axial directions during the grinding process.

In one embodiment of the present disclosure, the grinding member is a grinding wheel.

In one embodiment of the present disclosure, the plurality of axial directions are selected from at least two of the following groups: an X-axis, a Y-axis or a Z-axis in a coordinate system or a rotation axis.

The present disclosure also includes a gear processing method. The gear processing method comprising: providing a gear processing apparatus, the gear processing apparatus including a bearing unit that carries the gear and a grinding unit, the grinding unit including a driving module and a grinding member connected to the driving module; and using the grinding member to perform a motion of a plurality of axial directions relative to the bearing unit to contact a tooth surface of the gear; wherein the driving module applies an additional motion to at least one of the plurality of axial directions during a grinding process to drive the grinding member so as to grind the tooth surface of the gear.

Accordingly, the gear processing apparatus of the present disclosure can change the complex grinding texture formed on the tooth surface of the gear with interlaced and non-parallel patterns, and control the surface roughness, to avoid the noise generated at a specific frequency when the gear meshing and achieve the effect of noise reduction.

### BRIEF DESCRIPTION OF THE DRAWINGS

FIG. 1 is a block diagram of the gear processing apparatus of the present disclosure.

FIG. 2 is a schematic diagram of the structure of the gear processing apparatus according to the present disclosure.

FIG. 3 is a schematic diagram of the additional motion performed by the grinding unit of the gear processing apparatus according to the present disclosure.

FIG. 4 is a schematic diagram of a comparison of the grinding results of the tooth surface of the gear of the control group A and the experimental group B-C of the gear processing apparatus according to the present disclosure.

FIG. 5 is a flow chart of the gear processing method according to the present disclosure.

### DETAILED DESCRIPTION OF THE PREFERRED EMBODIMENTS

Since various aspects and embodiments are only illustrative and non-limiting, after reading this specification, those with ordinary knowledge may have other aspects and embodiments without departing from the scope of the present disclosure. According to the following detailed description and patent application scope, the features and advantages of these embodiments will be more prominent.

In present disclosure, “a” or “an” is used to describe the units, elements, and components described herein. This is done for convenience of description only and providing a general meaning to the scope of the present disclosure. Therefore, unless clearly stated otherwise, the description should be understood to include one, at least one, and the singular can also include plural.

In this specification, the terms “first” or “second” and other similar ordinal numbers are mainly used to distinguish or refer to the same or similar elements or structures, and do not necessarily imply that these elements or structures are in space or chronological order. It should be understood that in certain situations or configurations, ordinal numbers can be used interchangeably without affecting the implementation of this creation.

In this disclosure, the terms “including”, “having”, “containing” or any other similar terms are intended to encompass non-exclusive inclusive. For example, a component, structure, article, or device that contains a plurality element is not limited to such elements as listed herein but may include those not specifically listed but which are typically inherent to the component, structure, article, or device. In addition, the term “or” means an inclusive “or” rather than an exclusive “or” unless clearly stated to the contrary.

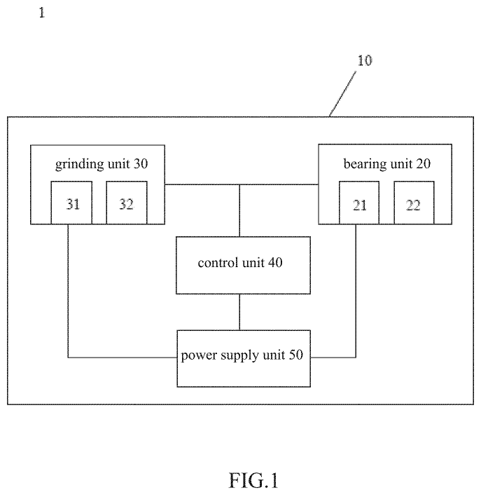

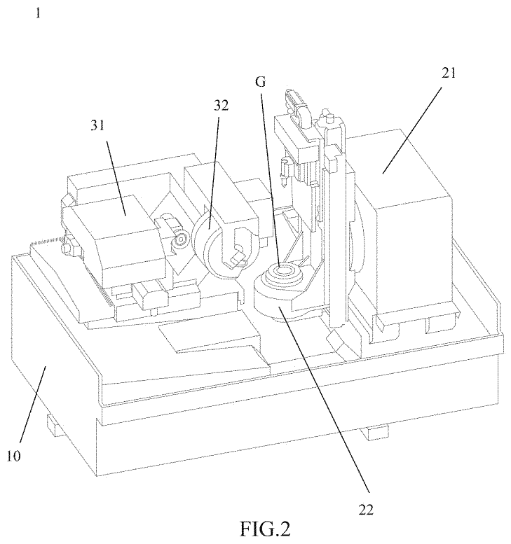

The gear processing apparatus of the present disclosure is configured to perform surface grinding processing on the tooth surface of the gear to reduce the surface roughness of the tooth surface of the gear. Please refer to FIG. 1 and FIG. 2 together, in which FIG. 1 is a block diagram of the gear processing apparatus of the present disclosure and FIG. 2 is a schematic diagram of the structure of the gear processing apparatus according to the present disclosure. As shown in FIG. 1 and FIG. 2, the gear processing apparatus 1 of the present disclosure comprises a base 10, a bearing unit 20, a grinding unit 30, and a control unit 40. The base 10 is the basic structure of the gear processing apparatus 1 of the present disclosure and is provided for the installation of various functional units or components.

The bearing unit 20 is arranged on the base 10. The bearing unit 20 is configured to carry the gear G to be processed. The bearing unit 20 includes a first driving module 21 and a bearing part 22, and the first driving module 21 is connected to the bearing part 22. The first driving module 21 can drive the bearing part 22 to perform a motion with a plurality of axial directions in conjunction with the grinding unit 30 to process the gear G. The bearing part 22 is configured to replace and fix the gear G to be processed. In one embodiment of the present disclosure, the first driving module 21 can drive the bearing part 22 to perform a single or multiple axial directional motion in a coordinate system, for example, move in a straight line along the X-axis, Y-axis, or Z-axis to relatively change the processing position of the gear G. The first driving module 21 can also drive the bearing part 22 to perform a rotation motion along a rotating axis to synchronously drive the gear G to rotate. Besides, in response to different needs, the first driving module 21 can further drive the bearing portion 22 to perform a partial deflection motion based on another rotation axis to relatively change the processing angle of the gear G. That is to say, in this embodiment, the plurality of axial directions is selected from at least one or a combination of the following groups: an X-axis, a Y-axis, or a Z-axis in a coordinate system or a rotation axis, but the present disclosure is not limited thereto.

The grinding unit 30 is arranged on the base 10. The grinding unit 30 is configured to perform a grinding operation against the gear G to be processed. The grinding unit 30 includes a second driving module 31 and a grinding member 32, and the second driving module 31 is connected to the grinding member 32. The second driving module 31 can drive the grinding member 32 to perform a motion of a plurality of axial directions relative to the bearing unit 20 to contact the tooth surface of the gear G and to grind the gear G. The grinding member 32 is configured to grind the gear G to be processed. In an embodiment of the present disclosure, the second driving module 31 can drive the grinding member 32 to perform a single or multiple axial motion in the coordinate system, for example, move in a straight line along the X-axis, Y-axis, or Z-axis to change the grinding position of the grinding element 32. The second driving module 31 can also drive the grinding member 32 to perform a rotational movement along a rotation axis to synchronously drive the grinding member 32 to rotate. Besides, in response to different needs, the second driving module 31 can further drive the grinding member 32 to perform a partial deflection motion based on another rotation axis to change the grinding angle of the grinding member 32. That is to say, in this embodiment, the plurality of axial directions are at least two selected from the following groups: an X-axis, a Y-axis, or a Z-axis in the coordinate system, or a rotation axis, but the present disclosure is not limited thereto.

In one embodiment of the present disclosure, the grinding element 32 is a grinding wheel. The following description takes a worm wheel as an example, but the present disclosure is not limited thereto. The direction of the rotation axis corresponding to the worm wheel and the direction of the rotation axis corresponding to the gear G are perpendicular to each other so that the grinding structure of the worm wheel and the tooth surface of the gear G mesh with each other during the grinding process to facilitate the execution of the grinding operation.

The control unit 40 is electrically connected to the bearing unit 20 and the grinding unit 30. In an embodiment of the present disclosure, the control unit 40 is also arranged on the base 10, so that the gear processing apparatus 1 of the present disclosure can form an integrated design, but the present disclosure is not limited thereto. For example, the control unit 40 can be separated from the base 10 in structural and be electrically connected to the bearing unit 20 and the grinding unit 30 only by wires. The control unit 40 can be a control chip, a processor or a computer host, etc., for transmitting instructions to control the first driving module 21 of the bearing unit 20 or/and the second driving module 31 of the grinding unit 30 so as to drive the grinding member 32 to perform the grinding operation on the gear G to be processed.

Besides, in an embodiment of the present disclosure, the gear processing apparatus 1 of the present disclosure further includes a power supply unit 50. The power supply unit 50 is electrically connected to the bearing unit 20, the grinding unit 30 and the control unit 40. The power supply unit 50 can be connected to an external power supply to provide the power required by the aforementioned units.

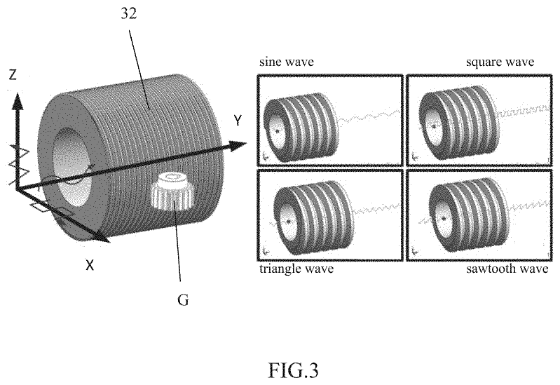

Please refer to FIG. 1 and FIG. 3. FIG. 3 is a schematic diagram of an additional motion performed by the grinding unit of the gear processing apparatus of the present disclosure. In addition to driving the grinding element 32 and the gear G to be processed to rotate respectively and move relative to each other to position by the control unit 40, during the grinding process, the gear processing apparatus 1 of the present disclosure mainly uses the control unit 40 to control the second driving module 31 to apply an additional motion to at least one of the plurality of axial directions (for example, the additional motion can be applied only to Y-axis, or the additional motion can be applied to X-axis, Y-axis, and Z-axis at the same time, etc.). Therefore, the grinding element 32 will be driven by the second driving module 31 to perform the grinding operation in the state of performing the additional motion. As shown in FIG. 3, in an embodiment of the present disclosure, the additional motion is a trace wave motion, and the wave motion is selected from at least one or a combination of the following groups: a sine wave motion, a square wave motion, a triangle wave motion or a sawtooth wave motion. Each wave motion has corresponding amplitude and frequency, and the amplitude or frequency of the wave motion can be adjusted according to different requirements.

In an embodiment of the present disclosure, the control unit 40 can control the second driving module 31 to apply different wave motions to the plurality of axial directions during the grinding process. For example, assuming that the plurality of axial directions includes the X-axis and the Y-axis, the control unit 40 can control the second driving module 31 to apply a square wave motion to the X-axis and a sine wave motion to the Y-axis. Furthermore, assuming that the plurality of axial directions includes the X-axis, the Y-axis, and the Z-axis, the control unit 40 can control the second driving module 31 to apply the square wave motion to the X-axis, the sine wave motion to the Y-axis, and the triangle wave motion to the Z-axis. However, the present disclosure is not limited thereto, and may be changed according to different requirements.

In one embodiment of the present disclosure, the control unit 40 can control the second driving module 31 to apply the same wave motions with different amplitudes or frequencies to the plurality of axial directions during the grinding process. For example, assuming that the plurality of axial directions includes the X-axis and the Y-axis, the control unit 40 can control the second driving module 31 to apply the sine wave motion to both the X-axis and the Y-axis, but the amplitude of the sine wave motion applied to the X-axis is 3.6 μm and the frequency is 30 Hz, while the amplitude of the sine wave motion applied to the Y-axis is 5.0 μm and the frequency is 30 Hz. However, the present disclosure is not limited thereto and may be changed according to different requirements.

In one of the embodiments of the present disclosure, the equations of wave motion corresponding to different wave motions applied to any axial direction is as follows:

$$\begin{matrix}\text{?} ( t ) = \text{?} sin ( \text{?} 2 π f t ) & ( 1 ) \\ \text{?} ( t ) = \frac{4 \text{?}}{π} \text{?} - \frac{1}{( i + 1 )} sin [ ( i + 1 ) \text{?} 2 π f t ] & ( 2 ) \\ \text{?} ( t ) = \text{?} \{ \text{?} \frac{1}{{( i + 4 )}^{2}} sin [ ( i + 4 ) \text{?} 2 π f t ] + \text{?} \frac{- 1}{{( j + 4 )}^{2}} sin [ ( j + 4 ) \text{?} 2 π f t ] \} \\ \text{?} ( t ) = \text{?} \text{?} - \frac{2}{i π} sin ( \text{?} 2 π f t ) & ( 3 ) \\ ( \text{?} = 20 , \text{?} = \text{?} = 50 , ω = 2 π f ) \\ \text{?} \text{indicates text missing or illegible when filed} & ( 4 )\end{matrix}$$

In the above equations, the subscripts 1 to 4 of v, a, b, and n respectively represent a sine wave, a square wave, a triangle wave, and a sawtooth wave; that is to say, the equation (1) on behalf of the equation for applying the sine wave motion, equation (2) on behalf of the equation for applying the square wave motion, equation (3) on behalf of the equation for applying the triangle wave motion, and equation (4) on behalf of the equation for applying the sawtooth wave motion. Wherein a and b respectively control the amplitude and the frequency of the waveform, w is the rotation speed, t is the time, and f is the frequency. The waveform is closer to the real shape when the value of n is larger.

By combining the above-mentioned corresponding wave motion equation with the original motion equation of each axis in the gear processing apparatus of the present disclosure, the corresponding grinding control equations for each axis can be obtained, and then roughness of the tooth surface of the gear and the shape of the grinding texture can be calculated.

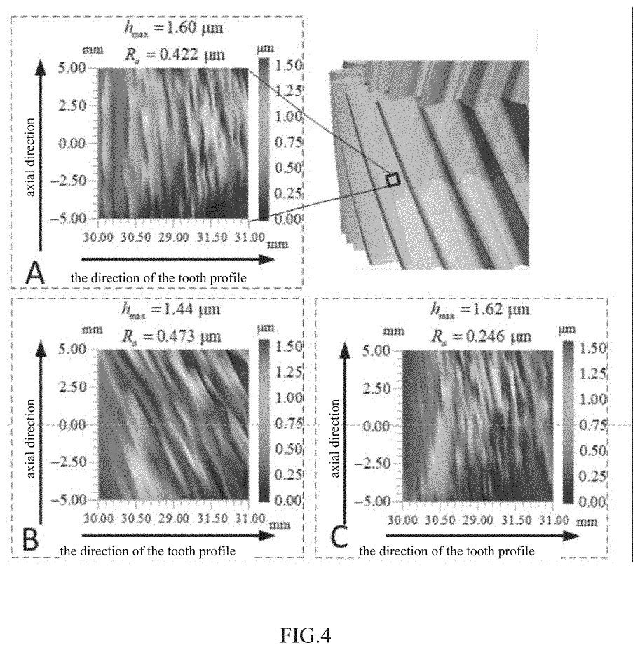

Please refer to FIGS. 1 and 4 together. FIG. 4 is a schematic diagram of a comparison of the grinding results of the tooth surface of the gear of the control group A and the experimental group B-C of the gear processing apparatus according to the present disclosure. In the following experiment, the gear processing apparatus 1 of the present disclosure is used to perform once grinding operation on the tooth surface of the gear with the same specification. The control group A was set under the condition that no wave motion was applied to the X-axis, the Y-axis, and the Z-axis. The experimental group B was set under the condition that the sine wave motion was applied to the X-axis, the Y-axis, and the Z-axis. The experimental group C was set under the condition that the square wave motion was applied to the X-axis, the Y-axis, and the Z-axis. Then, the image of the grinding result along the axial and tooth profile direction of the tooth surface of the gear after grinding operation, the maximum grinding depth and the roughness value of the tooth surface can be simulated and obtained. Wherein the frequencies of all wave motions to be applied are 30 Hz, the amplitudes of all wave motions applied to the X-axis are 3.6 μm, and the amplitudes of all wave motions applied to the Y-axis are 5.0 μm, and the amplitudes of all wave motions applied to the Z-axis are 4.0 μm, the feed rate of the axial direction of the worm wheel is 20 mm/s, the helix angle is 0°, the radius of the worm wheel is 200 mm, and the abrasive particle size of the worm wheel is 470 μm.

As shown in FIG. 4, after analyzing the experimental simulation results, the shape of the grinding texture of the control group A is approximately straight grinding texture, while the shape of the grinding texture of the experimental group B is approximately diagonal grinding texture, while the shape of the grinding texture of the experimental group C is approximately the same as that of the control group A is straight grinding texture. When the grinding texture is diagonal grinding texture, it can effectively reduce the single-frequency noise caused by gear meshing. Accordingly, the experimental group B for applying the sine wave motion can produce a better noise reduction effect than the control group A. However, the experimental group C for applying the square wave motion did not achieve much improvement in the shape of tooth surface grinding.

Then, in terms of the maximum grinding texture depth h max, the maximum grinding texture depth of the control group A is about 1.60 μm, the maximum grinding texture depth of the experimental group B is about 1.44 μm, and the maximum grinding texture depth of the experimental group C is about 1.62 μm. Compared with the control group A, the maximum grinding texture depth of the experimental group B is reduced by about 16%, while the improvement in experimental group C was limited in the depth of the grinding texture.

Moreover, In terms of the roughness of the tooth surface Ra, the roughness of the tooth surface of the control group A is about 0.422 μm, the roughness of the tooth surface of the experimental group B is about 0.473 μm, and the roughness of the tooth surface of the experimental group C is about 0.246 μm. Compared with the control group A, the experimental group C is significantly better than the experimental group B in improving the roughness value of the surface.

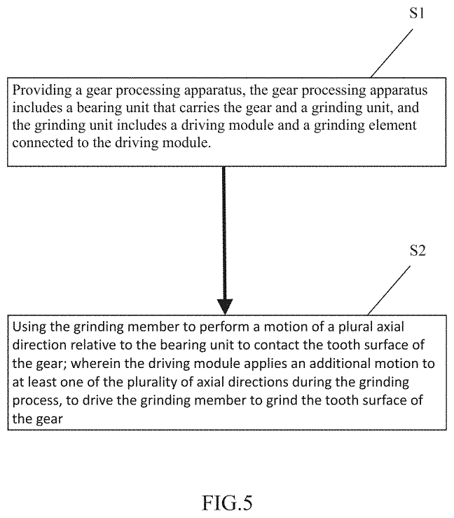

Please refer to FIG. 5 for a flow chart of the gear processing method according to the present disclosure. As shown in FIG. 5, the present disclosure further includes a gear processing method, which can be applied to the gear processing apparatus of the present disclosure or other apparatuses with similar functional characteristics. The gear processing method of the present disclosure includes the following steps:

Step S1: Providing a gear processing apparatus, the gear processing apparatus includes a bearing unit that carries the gear and a grinding unit, and the grinding unit includes a driving module and a grinding element connected to the driving module.

Step S2: Using the grinding member to perform a motion of a plurality of axial directions relative to the bearing unit to contact the tooth surface of the gear; wherein the driving module applies an additional motion to at least one of the plurality of axial directions during the grinding process, to drive the grinding member so as to grind the tooth surface of the gear.

In conclusion, the gear processing apparatus and method of the present disclosure can change the shape, angle, and depth of the grinding texture of the tooth surface of the gear by applying a small amount of additional motion to at least one of the plurality of axial directions when the grinding member performs the motions of the plural axial directions to form different roughness of the tooth surface, thereby reducing the noise generated by vibration when the gear has meshed and improving the quality and efficiency of the processed gear.

The above implementations are essentially only auxiliary descriptions and are not intended to limit the embodiments of the application subject or the applications or uses of the embodiments. Besides, although at least one illustrative example has been presented in the foregoing embodiments, it should be understood that considerable variation may still exist in the present invention. It should also be understood that the embodiments described herein are not intended in any way to limit the scope, use, or configuration of the subject matter of the application requested. On the contrary, the foregoing embodiments will provide a convenient guide for those skilled in the art to implement one or more of the above embodiments. Furthermore, variations in the function and arrangement of the elements may be made without leaving the scope of the patent application, and the scope of the patent application includes known equivalents and all foreseeable equivalents at the time of application of this patent application.

1. A gear processing apparatus for performing surface processing on a tooth surface of a gear, the gear processing apparatus comprising:
a base;
a bearing unit arranged on the base, the bearing unit carrying the gear;
a grinding unit arranged on the base, the grinding unit including a driving module and a grinding member connected to the driving module, the grinding member can perform a motion with a plurality of axial directions relative to the bearing unit to contact a tooth surface of the gear; and
a control unit being electrically connected to the bearing unit and the grinding unit, and being configured to control the driving module to apply an additional motion to at least one of the plurality of axial directions during a grinding process so as to drive the grinding member to grind the tooth surface of the gear.

2. The gear processing apparatus of claim 1, wherein the additional motion is a wave motion.

3. The gear processing apparatus of claim 2, wherein the wave motion is selected from at least one or a combination of the following groups: a sine wave motion, a square wave motion, a triangle wave motion, or a sawtooth wave motion.

4. The gear processing apparatus of claim 3, wherein the control unit controls the driving module to apply the different wave motions to the plurality of axial directions during the grinding process.

5. The gear processing apparatus of claim 3, wherein the control unit can control the driving module to apply the same wave motions with different amplitudes or frequencies to the plurality of axial directions during the grinding process.

6. The gear processing apparatus of claim 1, wherein the grinding member is a grinding wheel.

7. The gear processing apparatus of claim 1, wherein the plurality of axial directions are selected from at least two of the following groups: an X-axis, a Y-axis or a Z-axis in a coordinate system or a rotation axis.

8. A gear processing method for performing surface processing on the tooth surface of a gear, the gear processing method comprising:
providing a gear processing apparatus, the gear processing apparatus including a bearing unit that carries the gear and a grinding unit, the grinding unit including a driving module and a grinding member connected to the driving module; and,
using the grinding member to perform a motion of a plurality of axial directions relative to the bearing unit to contact a tooth surface of the gear;
wherein the driving module applies an additional motion to at least one of the plurality of axial directions during a grinding process to drive the grinding member so as to grind the tooth surface of the gear.

9. The gear processing method of claim 8, wherein the additional motion is a wave motion.

10. The gear processing method of claim 9, wherein the wave motion is selected from at least one or a combination of the following groups: a sine wave motion, a square wave motion, a triangle wave motion, or a sawtooth wave motion.

11. The gear processing method of claim 10, wherein the control unit controls the driving module to apply the different wave motions to the plurality of axial directions during the grinding process.

12. The gear processing method of claim 10, wherein the driving module to apply the same wave motions with different amplitudes or frequencies to the plurality of axial directions during the grinding process.
